(19) United States
(12) Patent Application Publication
(10) Pub. No.: US 2025/0365144 A1
(43) Pub. Date: Nov. 27, 2025

(54) Systems and Methods for Implementing Multi-Custody Control of Cryptographic Keys Using Cloud-Based Services

(71) Applicant: Intertrust Technologies Corporation, Berkeley, CA (US)

(72) Inventor: Stephen Mitchell, Ben Lomond, CA (US)

(73) Assignee: Intertrust Technologies Corporation, Berkeley, CA (US)

(21) Appl. No.: 19/219,944

(22) Filed: May 27, 2025

Related U.S. Application Data
(60) Provisional application No. 63/652,132, filed on May 27, 2024.

(51) Int. Cl. H04L 9/08; H04L 9/30

(52) U.S. Cl. CPC H04L 9/088; H04L 9/0819; H04L 9/3073

(57) ABSTRACT

Embodiments of the disclosed systems and methods facilitating multi-party control of protected cryptographic keys in cloud-based service architectures. Consistent with embodiments disclosed herein, secure enclaves associated with cloud service virtual machines may be leveraged in a manner such that multi-custody control of protected keys may be implemented, while cloud-service account root authority access to these keys may be restricted. In certain embodiments, policy managed by a key management system may persistently bind an application key to an enclave signing key, which may be placed under multi-custody control. With the application key being securely bound to the enclave signing key within enforced policy, the application kay may be effectively placed under multi-custody control within the cloud-based service.

### RELATED APPLICATIONS

This application claims the benefit of priority under 35 U.S.C. § 119 (e) to U.S. Provisional Application No. 63/652,132 filed May 27, 2024, and entitled “Systems and Methods for Implementing Multi-Custody Control of Cryptographic Keys Using Cloud-Based Services,” which is hereby incorporated by reference in its entirety

### COPYRIGHT AUTHORIZATION

Portions of the disclosure of this patent document may contain material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### SUMMARY OF THE INVENTION

The present disclosure relates generally to systems and methods for managing protected cryptographic keys. More specifically, the present disclosure relates to systems and methods for facilitating multi-party control of protected cryptographic keys in cloud-based service architectures.

When implementing a certificate authority (“CA”) and/or key management services, maintaining rigorous security protocols is an important design criterion, particularly in the context of audited security and general key management practices. To enhance security and ensure proper key management, many conventional services use multi-custody control mechanisms for various cryptographic keys.

For example, cryptographic keys handled by CAs may be subject to dual custody control, meaning that access to and usage of these keys require the participation of at least two authorized parties. For root keys, an even higher level of security may be implemented through custody control of additional parties (e.g., triple custody control, necessitating the participation of three authorized parties to access and/or use these keys).

To enforce these multi-custody control measures, technical controls may be established to ensure that a required number of participants, which may be referred to as key custodians, are actively involved in any operation involving the protected and/or otherwise managed keys. This may be achieved through on-premises physical security measures that may include the use of hardware security modules (“HSMs”). These HSMs may be equipped with physical tokens, and access to these tokens may be managed through physical secure storage solutions, such as safes. For example, physical smart cards may be presented by multiple participants in a custody control module for an associated protected key to be used.

By implementing these physical and/or technical controls, CA and/or other key services can ensure that cryptographic keys are only accessible and/or usable when the requisite number of authorized key custodians are present and/or otherwise allow such use, thereby maintaining the integrity and security of the key management process. Multi-custody control of keys, however, presents certain challenges in the context of cloud-based managed services. Such cloud-based managed services may include services implemented using Amazon Web Services (“AWS”), although other cloud-based managed services are also contemplated (e.g., Azure, Google Cloud, IBM Cloud, etc.).

In the case of an HSM using physical tokens to authorize key access, human key custodians may need to be physically present and perform an authorization act for each usage of the controlled key. In automated services (e.g., either on-premises or in the cloud), key custodians may act to preauthorize a controlled class of key usages, perhaps for a limited time and/or under other technically enforced conditions and purposes. Still in automated services, multiple authorizations may be required.

Many cloud-based services are hierarchical in nature and have per-account root authorities that may have single root access and/or authority in connection with account services and/or associated information, including keys, implemented by the cloud-based service. This account root authority may potentially defeat and/or otherwise circumvent the multiple participant nature and/or enhanced security of multi-custody key management paradigms. For example, an account root authority may have privileges that enable the manipulation and/or modification of key policies either directly and/or or via modification of other related services including, but not limited to identity and access management (“IAM”) accounts, roles, and/or privileges, potentially circumventing participation by multiple key custodians in certain key management processes.

Consistent with embodiments disclosed herein, systems and methods are presented for enabling multi-custody control and/or management of keys in connection with cloud-based services that may ameliorate, at least in part, certain challenges detailed above. In various embodiments, secure enclaves and/or trusted execution environments (“TEEs”), which may be generally referred to herein as secure enclaves and/or simply enclaves, may be offered by cloud-based services. These enclaves may be leveraged in a manner such that multi-custody control of protected keys may be implemented, while cloud-service account root authority access to these keys may be restricted.

In some embodiments, an application key may be bound to an enclave signing key. For example, within a key management system (“KMS”) of the cloud-based service, policy associated with the application key may be set such that this binding is considered unchangeable, frozen, and/or otherwise restricted, even by account root authorities, which in certain cloud-based services may be referred to as making the key “unmanageable.” While setting a key to an unmanageable state within KMS policy may be discouraged by cloud-based service providers-indeed, many such providers may actively warn users against such an action and may require users take certain actions such as setting an override flag and/or the like—in the context of implementing multi-custody control of keys consistent with embodiment disclosed herein, restricting the ability of an account root authority to change and/or otherwise access and/or use the key unilaterally may be desirable.

The enclave signing key may be placed under multi-custody control through any suitable implementation (e.g., via physical custody control methods, multi-party computation techniques, and/or the like). For example, an on-premises HSM may enable signing key access to be limited to a quorum of smart card bearers. In KMS, the application key can be securely bound to the signing key by applying to the application key a KMS key policy containing the signing key's certificate. Then use of the application key can be restricted to enclave code signed by the signing key. The application key policy may have certain permissions disabled, preventing administrators from accessing the application key by modifying the policy.

As the application key has been securely bound to the enclave signing key within KMS policy consistent with embodiments disclosed herein, the application key may be effectively placed under multi-custody control within the cloud-based service. That is, access to the application key may be limited to signed enclave code, and a quorum of key custodians may need to be involved to sign enclave code. At the time that the signing key is authorized to sign code to be executed within the enclave, each key custodian may verify that the code to be signed uses the application key in an authorized way (e.g., via code review), and, via a suitable console, that the application key policy is correctly configured. In this manner, multi-custody control of the application key within the enclave may be realized.

### BRIEF DESCRIPTION OF DRAWINGS

The inventive body of work will be readily understood by referring to the following detailed description in conjunction with the accompanying drawings, in which:

FIG. 1 illustrates a non-limiting example of an architecture for implementing multi-custody control of a key within a cloud-based service consistent with certain embodiments disclosed herein.

FIG. 2 illustrates a flow chart showing a non-limiting example of a method for managing keys in a multi-custody control paradigm performed by a key management service consistent with certain embodiments disclosed herein.

FIG. 3 illustrates a flow chart showing a non-limiting example of a method for managing keys in a multi-custody control paradigm performed by a user system consistent with certain embodiments disclosed herein.

FIG. 4 illustrates a non-limiting example of a system that may be used to implement certain embodiments of the systems and methods of the present disclosure.

### DETAILED DESCRIPTION OF THE INVENTION

A description of systems and methods consistent with embodiments of the present disclosure is provided herein. While several embodiments are described, it should be understood that the disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

The embodiments of the disclosure may be understood by reference to certain drawings. The components of the disclosed embodiments, as generally described and/or illustrated in the figures herein, could be arranged and designed in a wide variety of different configurations. Thus, the following description of the embodiments of the systems and methods of the disclosure is not intended to limit the scope of the disclosure, but is merely representative of possible embodiments of the disclosure. In addition, the steps of any method disclosed herein do not necessarily need to be executed in any specific order, or even sequentially, nor need the steps be executed only once, unless otherwise specified.

Moreover, it will be understood that, as used herein, a determination, process, and/or method step that is described as being “based on” some information is not necessarily exclusively based on that information, but indeed may be based at least in part on the information and/or a portion thereof and/or other information, even if not explicitly indicated as so. Moreover, it will be appreciated that all examples described herein are intended to be illustrative of applications of various embodiments of the disclosed systems and methods to facilitate an understanding of the embodiments, and are not intended to be limiting examples, even if not specifically identified as such.

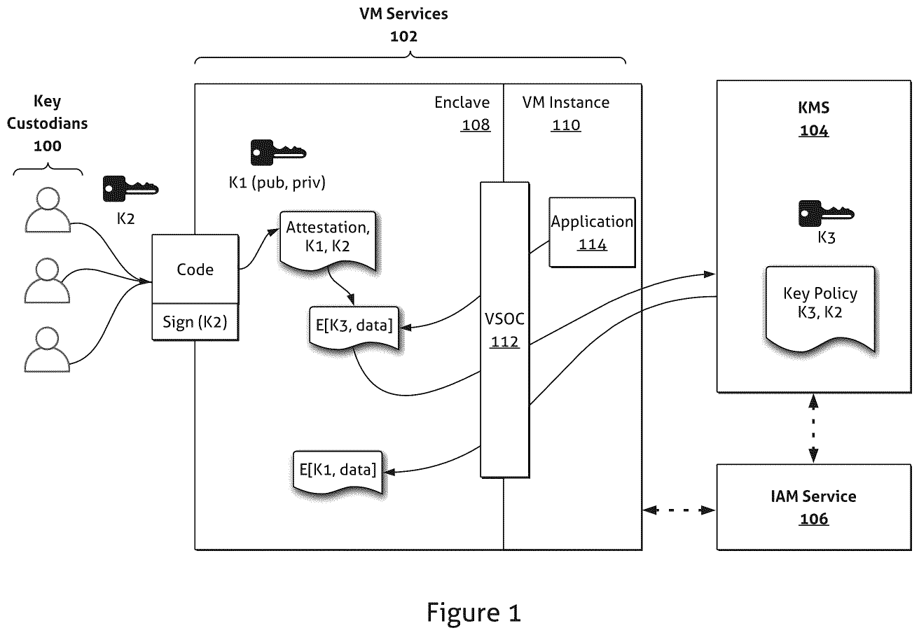

FIG. 1 illustrates a non-limiting example of an architecture for implementing multi-custody control of a key within a cloud-based service consistent with certain embodiments disclosed herein. As shown, a cryptographic signing key K2 may be placed under multi-party control of a plurality of participants 100, which may in certain instances be referred to herein as key custodians, using any suitable multi-custody key management technique. Under this multi-party control paradigm, access and/or use of the key may be restricted unless confirmed and/or otherwise permitted by the associated key custodians 100. Although three key custodians 100 are shown in connection with the illustrated architecture for purposes of illustration and explanation, it will be appreciated that any suitable number of key custodians may be used when implementing a multi-custody control paradigm in connection with the disclosed embodiments.

A cloud service provider may offer multiple, and potentially configurable, services to users and/or developers. For example, virtual machine (“VM”) services 102 and/or KMSs 104 may be offered by a cloud service provider. In some embodiments, KMSs 104 may be implemented by the cloud service using HSMs and associated keys managed by the KMSs 104 may be protected using HSM protection techniques.

Access to and/or use of these managed keys may be governed by an IAM service 106 of the cloud service. IAM services 106 may manage one or more policies relating to the use of various managed data and/or associated users/applications/services, including keys managed by the KMSs 104. In some implementations, such policies may be role based and/or hierarchical in nature, with account root authorities having broad and potentially unilateral control over such policies (and by extension, associated managed information, including keys), unless this authority and/or control is intentionally restricted (at least in part) via policy, as detailed herein.

Secure enclaves 108 may be attached to a VM instance 110 within the cloud service. In some embodiments, secure enclaves 108 may be isolated and/or otherwise protected from administrators and/or managers associated with the cloud service provider using a variety of suitable security techniques. Enclave data may not be directly managed by IAM services 106, although enclaves 108 themselves may be under IAM service control and/or management (e.g., in connection with lifecycle management of enclaves 108). Although only one VM instance 110 and/or associated secure enclave 108 is illustrated in the figure for purposes of simplicity and explanation, it will be appreciated that VM services 102 of a cloud service may instantiate a plurality of VM instances and/or secure enclaves, and that various aspects of the embodiments detailed herein may be extended across multiple VM instances and/or secure enclaves.

Secure enclaves 108 may be implemented by cloud service providers in a variety of ways, including using secure hardware (e.g., CPU hardware, hardware cards, etc.). In some embodiments, secure enclaves 108 may utilize virtual memory management units to prevent processes external to the enclave 108 and/or an associated TEE from accessing memory available in the enclave 108. Communication to and/or issued from an enclave 108 may utilize a virtual socket interface (“VSOC”) 112. Encrypted data may be passed to the enclave via the VSOC 112. For example, as illustrated, an application 114 executing within the VM instance 110 may pass encrypted data to the associated secure enclave 108 via the VSOC 112. The KMS 104 of the cloud service provider may also pass information to and/or receive information from the enclave through the VSOC 112.

In certain implementations, a secure enclave 108 may not have the ability to persist internal keys. For example, in certain embodiments the secure enclave 108 may be associated with a relatively limited resource set that can include processing resources, memory resources, and/or the VSOC 112 for facilitating communication, but not include resources allowing for persistent storage of keys. Consistent with embodiments disclosed herein, however, the secure enclave 102 may be capable of generating an ephemeral and/or temporary key using any suitable technique, illustrated in the figure as key K1, which may comprise an asymmetric key pair.

As the secure enclave 108 may not have resources to persist internal keys, the enclave 108 may interact with the KMS 104 via VSOC 112 to access and/or otherwise use certain persistent keys within the enclave 112, consistent with IAM enforced policy managed by the IAM service 106. For example and without limitation, in some embodiments, a policy may be associated with a KMS application key—K3—that details that the key is to be only used by code executing within a particular secure enclave 108 (potentially exclusively, although exclusive use may not be used in all implementations). In certain embodiments, the policy may restrict the use of the key K3 to specific enclave code.

For example and without limitation, in some embodiments the policy may require that the KMS application key K3 is to be used inside an enclave 108 (e.g., in connection with results encrypted with the ephemeral key K1) and that a hash of the enclave code must be a particular value. In further embodiments, the policy may associate the use of the KMS application key K3 within an enclave 108 that executes code signed with a particular key (e.g., enclave signing key K2) and/or or be associated with a particular code signing certificate. In this manner, a KMS application key K3 may be bound to a particular enclave code and/or an enclave signing key K2.

Attestation documents and/or associated mechanisms may be used in connection with various interactions with an enclave 108 and other services including, for example and without limitation, KMS 104. Attestation may enable an enclave 108 to authenticate its identity and establish trust with external services such as KMS 104. In some embodiments, an attestation document may be generated following a sequence of measurements, tests, and/or other evaluations performed on enclave code (e.g., hash evaluations, signature checks, etc.). These measurements, tests, and/or other evaluations may be employed to formulate access policies within external services, thereby allowing the enclave 108 to execute certain cryptographic operations.

For example and without limitation, in some embodiments, measurements on enclave code may be performed at load time (e.g., hashes of code, signing certificates, kernel versions, IAM role verification, certificate checks providing an indication that the enclave was booted from an enclave image file signed by a specific certificate, etc.). Resulting tags (e.g., hash tags) may be placed within an attestation document, which in some implementations may be referred to a platform configuration registers (“PCRs”). PCRs may be used as part of the attestation protocol to verify that an enclave has been instantiated with an expected codebase and/or configuration. A verifier may receive the attestation document which may compare the any PCR values against expected reference values to establish or refute the integrity and/or authenticity of the enclave.

The attestation document may be included (e.g., appended) to requests made by an enclave 108 to an external service such as a KMS 104. The KMS 104 may, upon receiving this request, compare the measurements, test results, and/or evaluation results contained within the attestation document with certain values in an access policy to determine whether to authorize the enclave 108 to perform a requested operation.

For example and without limitation, if code executing an enclave 108 wishes to decrypt a ciphertext using a particular key that should only be usable by code executing within the enclave 108 (e.g., KMS application key K3), the enclave 108 may issue a request via VSOC 110 to the KMS 104 with an associated attestation document. The attestation document may identify the enclave 108 and/or the associated code and provide measurements, test results, and/or evaluation results associated with the code and/or the enclave environment 108. In some embodiments, the attestation document may be signed with an attestation key. In further embodiments, the attestation document may include an indication that the enclave 108 has checked that the code has been signed (e.g., signed by enclave signing key K2) and that the signature has been validated, potentially including an indication of the key used by the enclave 108 to validate the signed code.

Consistent with embodiments disclosed herein, the enclave 108 may generate an ephemeral key pair K1 (K1, public and K1, private) using any suitable technique, and information relating to the public ephemeral key K1, public may be further included in the attestation document. In this manner, an attestation document may associate a request with an indication of the associated enclave 108 (and/or associated enclave information), the VM 110 the enclave 108 is attached to, an indication of the code associated with the request and/or signature validation of the code, and/or an indication of the public ephemeral key K1, public that was generated inside the enclave 108.

If the KMS application key K3 used to decrypt the ciphertext associated with the request is bound to an enclave 108 using an associated policy consistent with embodiments disclosed herein, the KMS 104 may not return the associated plaintext but, consistent with applicable policy, return the plaintext encrypted using the public ephemeral key K1, public that was passed in the attestation document (that is, return a new ciphertext encrypted with the public ephemeral key K1, public). In this manner, the new ciphertext may only be decrypted within the enclave 108 using the private ephemeral key K1, private.

Consistent with embodiments disclosed herein, the KMS application key K3 may be securely bound to the public enclave signing key K2, public (whose corresponding private key may be managed via multi-custody control mechanisms) via policy managed by the KMS 104. Once the enclave signing key K2 has been securely bound to the KMS application key K3 via policy, this policy may be set such that it is considered unchangeable, frozen, and/or otherwise restricted from account root authorities, which in certain cloud-based services may be referred to as making the KMS application key K3 for the enclave “unmanageable.” In this manner, the KMS application key K3 may be persistently bound to the enclave code, with the ability to change the policy managed by the KMS 104 binding the signing key K2 and the KMS application key K3 being limited or entirely disabled.

The signing key K2 may be placed under multi-custody control under one or more key custodians 100 through any suitable implementation (e.g., via physical custody control methods, multi-party computation techniques, and/or the like). As the KMS application key K3 may be securely bound to the enclave signing key K2 within persistent KMS-managed policy consistent with embodiments disclosed herein, the KMS application key K3 may be effectively placed under multi-custody control within the cloud-based service.

To illustrate a non-limiting cryptographic process consistent with the disclosed embodiments in reference to the architecture and flow of various information shown in FIG. 1, a group of key custodians 100 (three in the illustrated example) may share multi-custody control of an enclave signing key K2. Using this enclave signing key K2, they may sign a piece of code that is provided to the enclave 108 for execution within the enclave 108 (e.g., sign using a private enclave signing key). The enclave 108 may generate an ephemeral private/private key pair K1. An attestation document may be generated by the enclave that records that the code was signed by the signing key K2 and includes the public ephemeral key K1, public. In some embodiments, the document may be signed by an infrastructure key as part of the attestation. For example, the attestation may include a certificate that holds the public signing key K2, public. In this manner, the attestation document may be trusted and/or validated by a receiving service (e.g., the KMS 104) following a validation and/or authentication process.

As the enclave code executes within the enclave 108, it may receive ciphertext data encrypted under an application key K3 managed by the KMS 104 (i.e., E [K3, data]). The encrypted ciphertext and the attestation document may be passed by the enclave through VSOC 112 to the KMS 104. The KMS 104 may analyze the ciphertext encrypted under application K3 and the attestation associating the signing key K2 and the ephemeral key K1. The KMS 104 may identify a policy associating the signing key K2 and the application key K3 (that is, the previously described “frozen” and/or otherwise persistent policy). Using the available information, the KMS 104 may decrypt the ciphertext using the private symmetric application key K3, private producing plaintext data. Instead of releasing the plaintext data back to the enclave 108, however, it may encrypt it with the public ephemeral key K1 shared in the attestation document, returning this new ciphertext (i.e., E [K1, data]) into the enclave 108 via VSOC 112. The enclave 108 can then decrypt the received ciphertext using the private ephemeral key K1, priviate which is not shared outside the enclave 108, to access the plaintext data.

Although in certain instances various embodiments and examples herein illustrate a single ephemeral key K1, signing key K2, and KMS application key K3 for purposes of simplicity in explanation and illustration, it will be appreciated that in various embodiments this general representation of these keys may be implemented using asymmetric cryptographic key pairs—that is-public or private keys, with the appropriate public or private key of a key pair being used depending on the context. The application key K3 may be a symmetric key or an asymmetric key pair. In further embodiments, multiple signing keys K2 may be associated with an application key K3 tied to an enclave 108. In yet further embodiments, multiple application keys K3 could be tied to an enclave 108. For example and without limitation, policy may define that more than one signing key may be used in connection with certain operations as long as they are within an enclave signed by a first permitted group and/or an enclave signed by a second permitted group. Key custodians 100, when authorizing the use of the code signing key K2, may review the policies on accessed application keys K3.

Although in connection with various embodiments actions may be taken via policy to make the KMS application key K3 unmanageable by account root authorities and/or otherwise freeze policies associating the application key K3 with a signing key K2, further embodiments may provide certain mechanisms for accessing and/or using K3 under certain limited circumstances, which may be generally referred to herein as “extraordinary access.” In various embodiments, extraordinary access paradigms may be governed by multi-custody control and may be available inside or outside an enclave 108 for appropriate operations including, for example and without limitation, rolling back of state files, modifying state files, and/or the like. In some embodiments, extraordinary access may be achieved by exporting state file signing and/or encryption keys to a trusted third party that can respond in certain exigent circumstances. In further embodiments, extraordinary access enclave operations may be implemented that validate certain hard-coded “emergency credentials” before editing and/or resigning state files.

In some embodiments, extraordinary access paradigms may be implemented by embedding certain information in enclave code that allows for management and/or use of the application key K3. For example, in some embodiments, a request may be issued to the enclave 108 for use of application key K3 that may be verified against a hard-coded certificate of a higher-level authority (e.g., hard coded into enclave code). If a request is issued via VSOC 112 to the enclave 108 requesting use of the application K3 with an authority's signature, the code may compare that signature to the public key embedded in the code and, if the signature is verified, and other protocol protections are applied such as replay protection, the application K3 may be used. To preserve the multi-custody control aspects of the overall system, the private signing key used to generate the authority's signature (e.g., associated with a key in the hard-coded certificate) may itself be under multi-custody control using similar mechanisms as described for multi-custody control over the signing key K2.

The extraordinary access mechanisms, as enclave code functions, may be limited by controls such as revocation or expiration of the code signing certificate. If the code signing certificate expires or is revoked, the application key K3 and its policy may need to be replaced by a new equivalent application key, bound to a new code signing key K2.

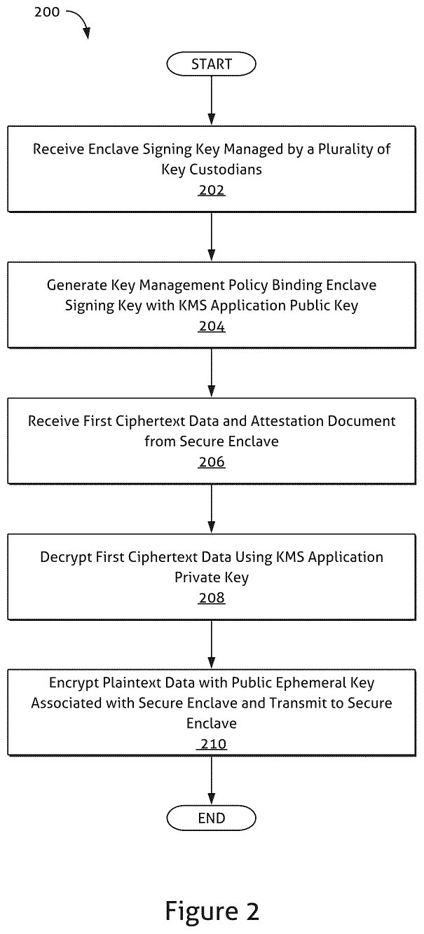

FIG. 2 illustrates a flow chart showing a non-limiting example of a method 200 for managing keys in a multi-custody control paradigm performed by a key management service consistent with certain embodiments disclosed herein. The illustrated method 200 may be implemented in a variety of ways, including using software, firmware, hardware, and/or any combination thereof. In certain embodiments, various aspects of the method 200 and/or its constituent steps may be performed by a cloud service provider, a KMS (which indeed may be a service of the cloud service provider), and/or associated systems and/or services.

At 202, the KMS may receive an enclave signing key (e.g., a public enclave signing key of an enclave signing key pair). Consistent with various embodiments disclosed herein, the enclave signing key may be under multi-custody control of a plurality of key custodians. In some embodiments, the enclave signing key may be unique to a secure enclave instance operating on a VM executed by a cloud service provider.

A key management policy may be generated by the KMS at 204. In some embodiments, this policy may be generated in response to user input and/or management actions with the KMS. In various embodiments, the key management policy may persistently bind the enclave signing key with a KMS application key (e.g., a KMS application public key). Consistent with embodiments disclosed herein, this persistent binding may be configured in policy such that one or more root authorities of the cloud service provider and/or the KMS may be unable to change the persistent binding of the enclave signing key with the KMS application key—this is, this aspect of the policy may be configured to be “unmanageable.”

At 206, first ciphertext data may be received from the secure enclave. The first ciphertext day may comprise plaintext data encrypted using the KMS application key (e.g., the KMS application public key). An attestation document may be further received from the secure enclave at 206. The attestation document may comprise a variety of information consistent with various aspects of the disclosed embodiments. For example and without limitation, the attestation document may include information associating the enclave signing key with an ephemeral key associated with the secure enclave (e.g., associating the public enclave signing key with a public ephemeral key generated by and/or otherwise associated with the secure enclave). In various embodiments, the public ephemeral key may also be included in the attestation document for use by the KMS. In some embodiments, the first ciphertext data and/or the attestation document may be received from the secure enclave via a VSOC.

The attestation document may further comprise a variety of other information that may be used by the KMS in connection with processing the first ciphertext data. For example and without limitation, the attestation document may further comprise identification information associated with the secure enclave, an indication and/or identification of code executing within the secure enclave, code evaluation, test, and or measurement results associated with the code executing within the secure enclave, an indication that a signature associated with the code executing within the secure enclave was validated by the secure enclave, and/or the like.

Based on the key management policy, it may be determined that the enclave signing key and the KMS application key are persistently bound by policy (e.g., that the enclave signing public key and the KMS application public key are bound in the key management policy). Based on this determination, the first ciphertext data may be decrypted at 208 using a KMS application private key associated with the KMS application public key to generate the plaintext data. At 210, the plaintext data may be encrypted using the public ephemeral key associated with the secure enclave (and communicated to the KMS with the attestation document) to generate second ciphertext data. This second ciphertext data may then be transmitted to the secure enclave (e.g., via a VSOC).

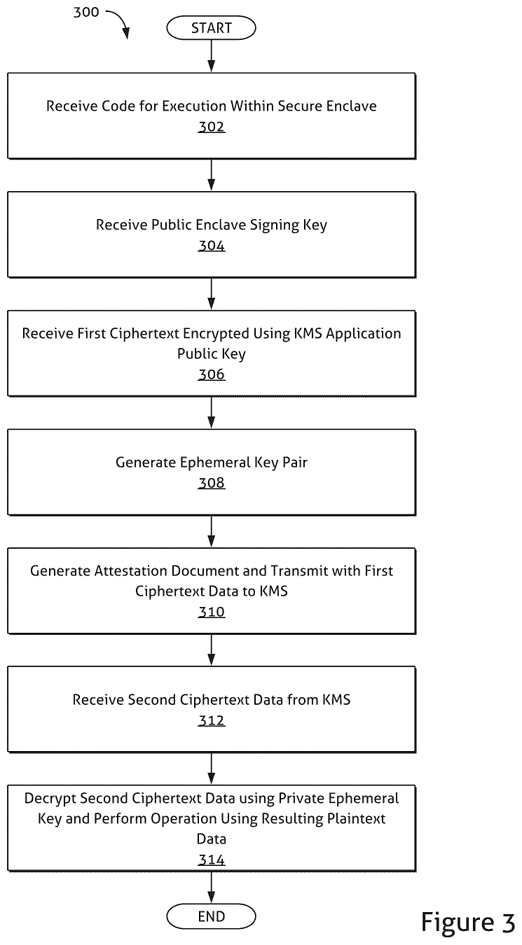

FIG. 3 illustrates a flow chart showing a non-limiting example of a method 300 for managing keys in a multi-custody control paradigm performed by a user system consistent with certain embodiments disclosed herein. The illustrated method 300 may be implemented in a variety of ways, including using software, firmware, hardware, and/or any combination thereof. In certain embodiments, various aspects of the method 300 and/or its constituent steps may be performed by a cloud service provider, a VM and/or secure enclave instance (which may be provided by the cloud service provider), a KMS (which may be a service of the cloud service provider), and/or associated systems and/or services.

At 302, code may be received for execution within the secure enclave. In some embodiments, the code may be signed by a private enclave signing key of an enclave signing key pair. Consistent with various embodiments disclosed herein, the private enclave signing key may be under multi-custody control of a plurality of key custodians. In some embodiments, the enclave signing key pair may be unique to a secure enclave instance operating on a VM executed by a cloud service provider.

A corresponding public enclave signing key of the enclave signing key pair associated with the private enclave signing key may be received by the secure enclave at 304. In some embodiments, the signature on the code may be validated using the public enclave signing key. At 306, first ciphertext data may be received by the secure enclave. In some embodiments, the first ciphertext data may comprise plaintext data encrypted using a KMS application public key. In some embodiments, the method may further comprise receiving a request to operate on the first ciphertext data using the code executing within the secure enclave.

The secure enclave may generate an ephemeral key pair associated with the secure enclave instance at 308 that may comprise a private ephemeral key and a public ephemeral key. In various embodiments, the private ephemeral key may be protected within and/or otherwise not shared outside of the secure enclave instance.

At 310, an attestation document may be generated by the secure enclave. The attestation document may comprise, for example and without limitation, the public ephemeral key and/or an association between the enclave signing key pair and the public ephemeral key. The first ciphertext data and the generated attestation document may also be transmitted to the KMS at 310. In some embodiments, the first ciphertext data and the attestation document may be transmitted to the KMS via a VSOC associated with the secure enclave.

The attestation document may further comprise a variety of other information associated with the secure enclave. For example and without limitation, the attestation document may further comprise identification information associated with the secure enclave, an indication and/or identification of the code, code evaluation, test, and or measurement results associated with the secure enclave code, an indication that a signature associated with the code was validated by the secure enclave, and/or the like.

At 312, in response to the transmitted first ciphertext data and the attestation document, the secure enclave may receive second ciphertext data from the KMS. In some embodiments, the second ciphertext data may be received from the KMS via the VSOC. The second ciphertext data may comprise the plaintext data (e.g., the decrypted first ciphertext data) first ciphertext data encrypted using the public ephemeral key.

The secure enclave may decrypt the second ciphertext data at 314 using the private ephemeral key (which in some embodiments may not be exposed outside of the enclave) to generate plaintext data for use within the secure enclave. At least one operation may be performed on the plaintext data using the code executing within the secure enclave.

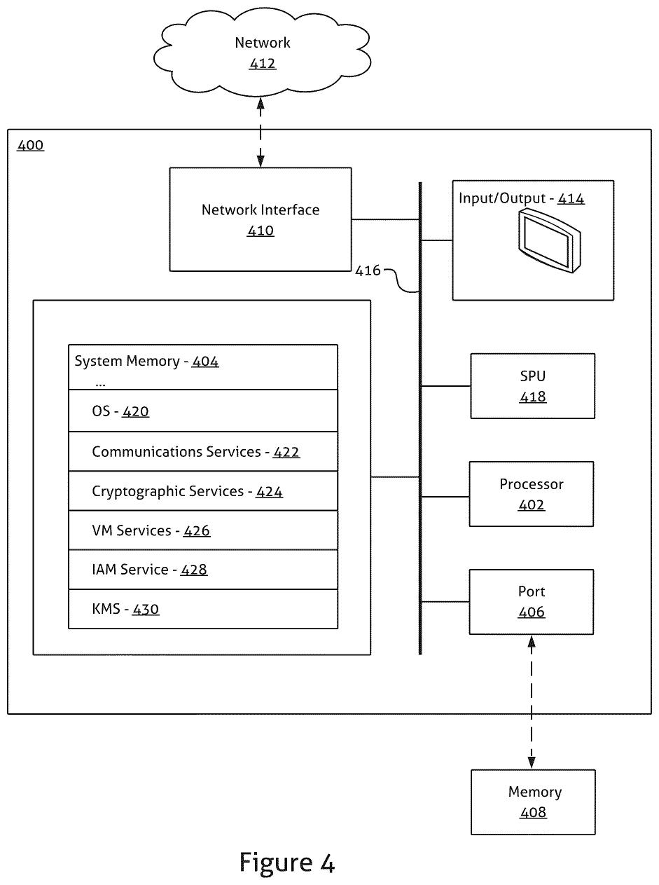

FIG. 4 illustrates an example of a system 400 that may be used to implement certain embodiments of the systems and methods of the present disclosure. The various systems, services, and/or devices used in connection with aspects the disclosed embodiments may be communicatively coupled using a variety of networks and/or network connections (e.g., network 412). In certain embodiments, the network 412 may comprise a variety of network communication devices and/or channels and may utilize any suitable communications protocols and/or standards facilitating communication between the systems and/or devices.

The network 412 may comprise the Internet, a local area network, a virtual private network, and/or any other communication network utilizing one or more electronic communication technologies and/or standards (e.g., Ethernet or the like). In some embodiments, the network 412 may comprise a wireless carrier system such as a personal communications system (“PCS”), and/or any other suitable communication system incorporating any suitable communication standards and/or protocols. In further embodiments, the network 412 may comprise an analog mobile communications network and/or a digital mobile communications network utilizing, for example, code division multiple access (“CDMA”), Global System for Mobile Communications or Groupe Special Mobile (“GSM”), frequency division multiple access (“FDMA”), time divisional multiple access (“TDMA”) standards, 4G and/or 5G communication standards (e.g., Long-Term Evolution (“LTE”), 5G New Radio (“NR”), orthogonal frequency division multiple access (“OFDMA”), etc.). In certain embodiments, the network 412 may incorporate one or more satellite communication links. In yet further embodiments, the network may utilize IEEE's 802.11 standards, Bluetooth®, ultra-wide band (“UWB”), Zigbee®, and or any other suitable standard or standards.

The various systems and/or devices used in connection with aspects of the disclosed embodiments may comprise a variety of computing devices and/or systems, including any computing system or systems suitable to implement the systems and methods disclosed herein. For example, the connected devices and/or systems may comprise a variety of computing devices and systems, including laptop computer systems, desktop computer systems, server computer systems, distributed computer systems, smartphones, tablet computers, and/or the like.

In certain embodiments, the systems and/or devices may comprise at least one processor system configured to execute instructions stored on an associated non-transitory computer-readable storage medium. As discussed in more detail below, systems used in connection with implementing various aspects of the disclosed embodiments may further comprise a secure processing unit (“SPU”) configured to perform sensitive operations such as trusted credential and/or key management, cryptographic operations, secure policy management, and/or other aspects of the systems and methods disclosed herein. The systems and/or devices may further comprise software and/or hardware configured to enable electronic communication of information between the devices and/or systems via a network using any suitable communication technology and/or standard.

As illustrated in FIG. 4, the example system 400 may comprise: a processing unit 402; system memory 404, which may include high speed random access memory (“RAM”), non-volatile memory (“ROM”), and/or one or more bulk non-volatile non-transitory computer-readable storage mediums (e.g., a hard disk, flash memory, etc.) for storing programs and other data for use and execution by the processing unit 402; a port 406 for interfacing with removable memory 408 that may include one or more diskettes, optical storage mediums (e.g., flash memory, thumb drives, USB dongles, compact discs, DVDs, etc.) and/or other non-transitory computer-readable storage mediums; a network interface 410 for communicating with other systems via one or more network connections and/or networks 412 using one or more communication technologies; a user interface 414 that may include a display and/or one or more input/output devices such as, for example, a touchscreen, a keyboard, a mouse, a track pad, and the like; and one or more busses 416 for communicatively coupling the elements of the system.

In some embodiments, the system 400 may, alternatively or in addition, include an SPU 418 that is protected from tampering by a user of the system 400 or other entities by utilizing secure physical and/or virtual security techniques. An SPU 418 can help enhance the security of sensitive operations such as personal information management, trusted credential and/or key management, privacy and policy management, and other aspects of the systems and methods disclosed herein. In certain embodiments, the SPU 418 may operate in a logically secure processing domain and be configured to protect and operate on secret information, as described herein. In some embodiments, the SPU 418 may include internal memory storing executable instructions or programs configured to enable the SPU 418 to perform secure operations, as described herein.

The operation of the system 400 may be generally controlled by the processing unit 402 and/or an SPU 418 operating by executing software instructions and programs stored in the system memory 404 (and/or other computer-readable media, such as removable memory 408). The system memory 404 may store a variety of executable programs or modules for controlling the operation of the system 400. For example, the system memory may include an operating system (“OS”) 420 that may manage and coordinate, at least in part, system hardware resources and provide for common services for execution of various applications. The system memory 404 may further include, without limitation, communication software 422 configured to enable in part communication with and by the system 400, cryptographic services 424 configured to perform certain secure cryptographic operations, VM services 216 configured to implement various aspects of VM instance instantiation and/or secure enclave generation and/or management, IAM services 428, KMS services 430, and/or any other information and/or applications configured to implement embodiments of the systems and methods disclosed herein and/or aspects thereof.

The systems and methods disclosed herein are not inherently related to any particular computer, electronic control unit, or other apparatus and may be implemented by a suitable combination of hardware, software, and/or firmware. Software implementations may include one or more computer programs comprising executable code/instructions that, when executed by a processor, may cause the processor to perform a method defined at least in part by the executable instructions. The computer program can be written in any form of programming language, including compiled or interpreted languages, and can be deployed in any form, including as a standalone program or as a module, component, subroutine, or other unit suitable for use in a computing environment. Further, a computer program can be deployed to be executed on one computer or on multiple computers at one site or distributed across multiple sites and interconnected by a communication network.

Software embodiments may be implemented as a computer program product that comprises a non-transitory storage medium configured to store computer programs and instructions, that when executed by a processor, are configured to cause the processor to perform a method according to the instructions. In certain embodiments, the non-transitory storage medium may take any form capable of storing processor-readable instructions on a non-transitory storage medium. A non-transitory storage medium may be embodied by a compact disk, digital-video disk, a magnetic disk, flash memory, integrated circuits, or any other non-transitory digital processing apparatus memory device.

Although the foregoing has been described in some detail for purposes of clarity, it will be apparent that certain changes and modifications may be made without departing from the principles thereof. For example, it will be appreciated that a number of variations can be made to the various embodiments, systems, services, and/or components presented in connection with the figures and/or associated description within the scope of the inventive body of work, and that the examples presented in the figures and described herein are provided for purposes of illustration and explanation, and not limitation. It is further noted that there are many alternative ways of implementing both the systems and methods described herein. Accordingly, the present embodiments are to be considered as illustrative and not restrictive, and the embodiments of the invention are not to be limited to the details given herein, but may be modified within the scope and equivalents of the appended claims.

1. A method of managing secure data performed by a key management service, the method comprising:
receiving an enclave signing key, the enclave signing key being associated with a plurality of key custodians and a secure enclave associated with a virtual machine executed by a cloud service provider;
generating a key management policy, the key management policy persistently binding the enclave signing key with a key management service application public key, wherein generating the key management policy comprises restricting within the key management policy one or more root authorities of the cloud service provider from changing the persistent binding of the enclave signing key with the key management service application public key;
receiving, from the secure enclave, first ciphertext data comprising plaintext data encrypted using the key management service application public key and an attestation document, the attestation document associating the enclave signing key with a public ephemeral key associated with the secure enclave and comprising the public ephemeral key;
determining, based on the key management policy, that the enclave signing key and the key management service application public key are persistently bound;
based on the determination:
decrypting the first ciphertext data using a key management service application private key associated with the key management service application public key to generate the plaintext data, and
encrypting the plaintext data using the public ephemeral key associated with the secure enclave to generate second ciphertext data; and
transmitting the second ciphertext data to the secure enclave.

2. The method of claim 1, wherein the first ciphertext data is received from the secure enclave via a virtual socket interface associated with the secure enclave.

3. The method of claim 2, wherein transmitting the second ciphertext data comprises transmitting the second ciphertext data via the virtual socket interface.

4. The method of claim 1, wherein decrypting the first cyphertext data and encrypting the plaintext data using the public ephemeral key is based, at least in part, on the contents of the attestation document.

5. The method of claim 4, wherein the attestation document further comprises identification information associated with the secure enclave.

6. The method of claim 4, wherein the attestation document further comprises an indication of associated code executing within the secure enclave.

7. The method of claim 4, wherein the attestation document comprises code evaluation results generated based on code executing within the secure enclave.

8. The method of claim 4, wherein the attestation document comprises an indication that a signature associated with code executing within the secure enclave was validated by the secure enclave.

9. The method of claim 1, wherein the key management service comprises a service of the cloud service provider.

10. The method of claim 1, wherein the enclave signing key comprises a key of a public and private key pair.

11. A method of managing secure data performed by a secure enclave associated with a virtual machine executed by a cloud service provider, the method comprising:
receiving code for execution within the secure enclave, the code being signed by a private enclave signing key of an enclave signing key pair, the private enclave signing key being associated with a plurality of key custodians;
receiving a public enclave signing key of the enclave signing key pair associated with the private enclave signing key;
receiving first ciphertext data comprising plaintext data encrypted using a key management service application public key;
generating an ephemeral key pair associated with the secure enclave, the ephemeral key pair comprising a private ephemeral key and a public ephemeral key;
generating an attestation document, the attestation document comprising:
the public ephemeral key; and
an association between the enclave signing key pair and the public ephemeral key;
transmitting the first ciphertext data and the attestation document to a key management service;
receiving, from the key management service in response to transmitting the first ciphertext data and the attestation document, second ciphertext data, the second ciphertext data comprising the plaintext data encrypted using the public ephemeral key;
decrypting the second ciphertext data using the private ephemeral key to generate plaintext data for use within the secure enclave; and
performing at least one operation using the plaintext data by the code within the secure enclave.

12. The method of claim 11, wherein the first ciphertext data and the attestation document are transmitted from the secure enclave to the key management service via a virtual socket interface associated with the secure enclave.

13. The method of claim 12, wherein receiving the second ciphertext data comprises receiving the second ciphertext data via the virtual socket interface.

14. The method of claim 11, wherein the key management service comprises a service of the cloud service provider.

15. The method of claim 11, wherein the method further comprises receiving a request to operate on the first ciphertext data using the code.

16. The method of claim 11, wherein the private ephemeral key is not exposed outside the secure enclave.

17. The method of claim 11, wherein the method further comprises validating a signature on the code using the public enclave signing key.
